(19) United States
(12) Patent Application Publication
(10) Pub. No.: US 2004/0125969 A1
(43) Pub. Date: Jul. 1, 2004

(54) Tri axial speaker system

(76) Inventors: William J. Kieltyka, Brunswick, ME (US); Isaac I. Ferstenberg, Edgewater, NJ (US)

Correspondence Address: FREDERICK R. CANTOR, ESQ, POST OFFICE BOX 87, SOUTH FREEPORT, ME, 04078-0087, US

(21) Appl. No.: 10/328,994

(22) Filed: Dec. 26, 2002

(51) Int. Cl. H04R 25/00; H04R 1/02; H04R 1/20

(52) U.S. Cl. 381/182; 381/345

(57) ABSTRACT

A loud speaker system can include a single woofer and two separate high frequency tweeters coaxially arranged, with the tweeters in back-to-back relation. One tweeter generates a high frequency pressure wave in the space proximate to the woofer diaphragm. The other tweeter directs a high frequency pressure wave directly away from the woofer diaphragm. The woofer diaphragm acts as a reflector for the first high frequency wave, so that the first high frequency wave radiates along the woofer diaphragm surface for merger with the other high frequency wave. The merged waves produce a high frequency wave front having a desired density and wide dispersion window.

### FIELD OF THE INVENTION

This invention relates to a loud speaker system and particularly to a speaker system employing a relatively large diameter woofer diaphragm for reproducing low frequency sounds, and two relatively small diameter diaphragms for reproducing high frequency sounds.

### BACKGROUND AND SUMMARY OF THE INVENTION

Audio loud speaker systems commonly employ a relatively large diameter woofer diaphragm for reproducing low frequency sounds, and two small diameter diaphragms (pistons) for reproducing high frequency sounds (above 4,000 hertz). U.S. Pat. No. 5,635,686 to R. Fenton, and U.S. Pat. No. 6,134,332 to D. Wiener, show speaker arrangements employing a woofer diaphragm and two tweeter diaphragms.

The use of multiple tweeter diaphragms is advantageous in that air displacement is increased (for improved decibel output) while still achieving timely response to high frequency signals. However, multiple tweeter diaphragms are usually arranged so that their acoustical centers are offset or out of alignment, so that the high frequency output pattern is somewhat uneven or irregular.

The present invention relates to a loudspeaker system that includes a single woofer diaphragm having a movement axis, and two separate tweeters diaphragms located coaxially on the movement axis, so that the high frequency wave centers are coaxial with the low frequency acoustical center.

As herein proposed, one of the tweeter diaphragms (piston) faces toward the woofer diaphragm for generating a first high frequency wave in the space between the two diaphragms. The other tweeter diaphragm faces away from the woofer diaphragm for generating a second high frequency wave directed away from the woofer diaphragm.

The first high frequency wave is reflected from the face of the woofer diaphragm into an annular zone surrounding the high frequency tweeters so as to be redirected by the woofer diaphragm outwardly for eventual merger with the second high frequency wave.

The herein proposed speaker system is advantageous in that two tweeter drivers are used, whereby a satisfactory high frequency wave decibel level is achieved. Also, since the high frequency output is coaxial with the low frequency output, there is a relatively smooth transition between the woofer sound output and tweeter sound output.

With the proposed arrangement, the dual high frequency drivers produce a smoother roll-off of sound, especially off-axis. The integration of energy from the front and rear tweeters creates a denser sound field, which tends to produce a wide even sound dispersion. The sound window (or dispersion angle) can approach one hundred forty degrees, measured from the center of the woofer diaphragm.

In general, the front tweeter (facing away from the woofer diaphragm) produces high frequency waves along the speaker axis, whereas the rear tweeter (facing the woofer diaphragm) generates an annular sound wave that surrounds and merges with the on-axis high frequency wave. The annular high frequency wave improves the dispersion angle (up to about one hundred forty degrees) while maintaining the density of the high frequency output over the entire wave front.

Further features of the invention will be apparent from the attached drawings and description of a preferred embodiment of the invention.

### BRIEF DESCRIPTION OF THE DRAWINGS

FIG. 1 is a sectional view taken through a loud speaker system constructed according to the invention.

FIG. 2 is a pictorial representation of a sound wave reflection phenomena that takes place during operation of the FIG. 1 speaker system.

### DESCRIPTION OF A PREFERRED EMBODIMENT OF THE INVENTION

The drawings show a loud speaker system that includes three drivers, namely a single woofer 10 for reproducing low frequency sounds, and two separate tweeters (drivers) for reproducing high frequency sounds, e.g. sounds represented by sound wave frequencies above 4,000 hertz. One of the tweeters is referenced by numeral 12; the other tweeter is referenced by numeral 14.

Woofer 10 is supported within a loudspeaker housing 16 by means of a frame 18. As shown, the frame has a flange 20 that is suitably secured to an inturned housing flange 22. The woofer includes a dish-like diaphragm 24 having an outer peripheral suspension (surround) 26 suitably anchored to flange 20 by a clamping ring 28.

Diaphragm 24 carries a light weight cylinder 30 that serves as a mount for an annular voice coil 32. The diaphragm is centered within an air gap of a permanent magnet circuit 36 by means of an inner suspension (spider) 34, whereby the voice coil 32 generates a frictionless true axial force on the diaphragm in response to an electric input signal to the coil. Alternatively, a spiderless system can be used, as shown in U.S. Pat. No. 5,802,193.

Diaphragm 24 is preferably a thin gage aluminum stamping resistant to high frequency break-up, such that diaphragm 24 moves axially without high frequency flexing of the diaphragm wall. The curved dish-like diaphragm configuration acts as a wall stiffener, but may also be straight-sided with a concave central area apex.

The permanent magnet circuit 36 for the woofer is a conventional arrangement that includes an assembly of magnetized components, together with a magnetically permeable pole piece 38 located on the movement axis 40 of the woofer diaphragm 24. The electrically generated field associated with voice coil 32 interacts with the constant field generated by magnetic circuit 36 to produce axial movement of diaphragm 24, thereby creating pressure waves in the space above the diaphragm.

It will be appreciated that the speaker system can be oriented in any direction, e.g. with diaphragm 24 facing in any selected location (upwardly, downwardly, horizontally, etc.). The woofer audio output will be centered on movement axis 40 in a direction away from the concave surface of diaphragm 24.

The high frequency tweeters 12 and 14 are constructed generally similarly to each other, with a minor difference in the tweeter diaphragm (piston) design. The two oppositely-facing tweeters are located in a single housing 42 that is attached to an overhead strut 43 that extends diametrically across the space above woofer diaphragm 24. The two tweeters 12 and 14 are coaxially located on movement axis 40 of the woofer diaphragm 24, so that high frequency pressure waves generated by the tweeter diaphragms are centered on axis 40.

Each tweeter comprises a diaphragm (light weight piston) 44 or 45, that carries a voice coil 47 located within an air gap of a permanent magnetic circuit 46. Each magnetic circuit includes a pole piece 48 located on movement axis 40. The field generated by each voice coil 47 interacts with the respective magnetic circuit 46 to create sound-producing pressure waves in the space proximate to the end face of the diaphragm (piston).

The tweeters are arranged in back-to-back relation, so that diaphragm 44 of tweeter 12 directs high frequency pressure waves downwardly toward the concave face of woofer diaphragm 24, whereas diaphragm 45 of tweeter 14 directs high frequency pressure waves upwardly away from the woofer diaphragm.

The raw input signal for the speaker voice coils is divided into two separate frequency bands by a crossover circuit (network), such that only low frequency signals are applied to voice coil 32, whereas only high frequency signals are applied to each voice coil 47. Each voice coil 47 receives a similar signal, so that diaphragms (pistons) 44 and 45 move generally simultaneously, but in opposite directions. The crossover circuit for treating the raw input signal may be located on a circuit board 50 suitably mounted within housing 16.

The exposed faces of tweeter diaphragms (pistons) 44 and 45 can have different curvatures. As shown, piston 44 has a flat surface curvature, whereas piston 45 has a curved convex surface curvature. The piston surface curvature affects the nature of the pressure wave generated by the respective piston.

The flat surface on piston 44, may tend to produce a column like pressure wave that is confined to a cylindrical envelope, designated by dashed line 52 in the drawing. The convexly curved end surface on piston 45, may tend to produce a diverging pressure wave.

The surface of woofer diaphragm 24 in axial alignment with piston 44 acts as a reflector to pressurize the zone between piston 44 and woofer diaphragm. The concave surface of diaphragm 24 tends to reflect the pressure wave angularly toward movement axis 40, so that the pressurized condition tends to be confined within the imaginary cylindrical envelope 52 while the pressure wave is being generated. The concave nature of the diaphragm 24 surface proximate to movement axis 40 prevents the pressure wave from radiating or diverging outwardly along the diaphragm 24 surface prematurely, i.e. prior to full development of peak pressure.

FIG. 2 is a diagram illustrating roughly the effect of the concave diaphragm surface on the pressure wave. FIG. 2 depicts a piston A moving downwardly in a cylinder B to pressurize a liquid in the space between the piston and the cylinder end wall. The liquid pressure is generally confined within the columnar cylinder B until the pressure is elevated, whereupon the liquid pressure forces the liquid radially outwardly through ports in the cylinder side wall. The liquid pressure is redirected from an axial direction to a radial direction without premature divergence.

The concave surface of diaphragm 24 proximate to movement axis 40 acts somewhat in the same fashion as the cylinder wall in FIG. 2, in that the concave surface maintains the air between the diaphragm and piston 44 as a pressurized column while the pressure is being developed. The concave diaphragm surface prevents premature divergence of the pressure wave away from movement axis 40.

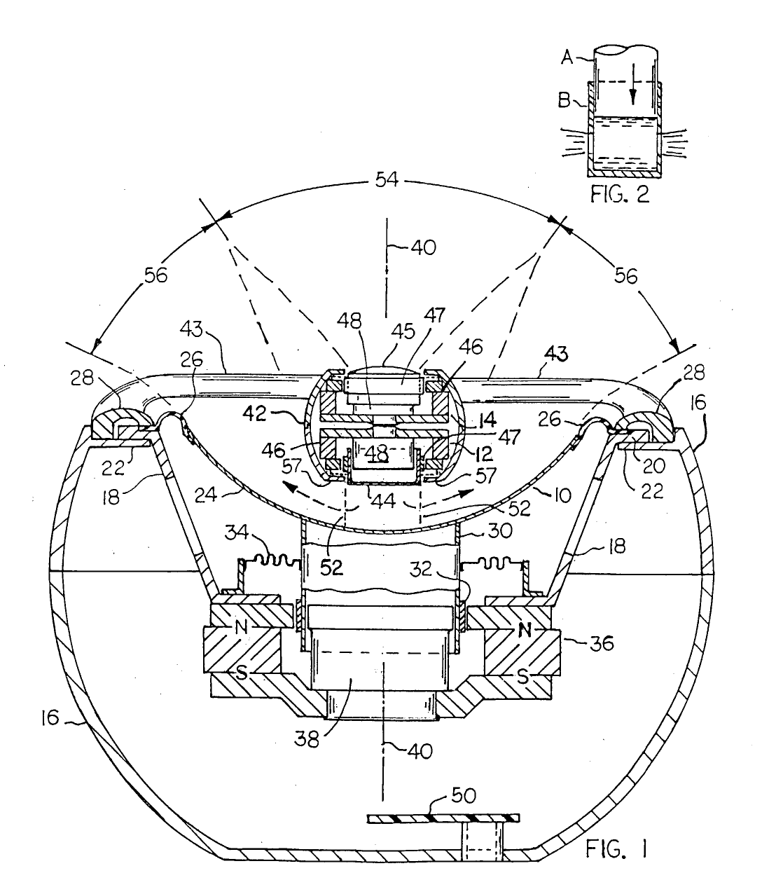

As shown by the arrows in FIG. 1, the pressure wave generated by piston 44 moves radially outwardly along the upper surface of diaphragm 24 for merger with the pressure wave generated by piston (diaphragm) 45. The concave dish-like surface of diaphragm 24 is continuous and free of discontinuities or abrupt changes in curvature that might tend to interfere with travel of the high frequency wave along the diaphragm 24 surface.

The pressure wave formed by the two tweeters 12 and 14 includes a central wave section indicated by numeral 54, and an annular outer section referenced by numeral 56. The two wave sections combine as a single wave front having a relatively large dispersion angle, approaching one hundred forty degrees (measured from the center of diaphragm 24). This is advantageous in that the audio output can be heard by an audience offset considerably from central axis 40 (i.e. seventy degrees in any direction).

The high frequency output is produced by two separate tweeters, so that the density of the high frequency output can be maintained over the entire span of the wavefront. Each tweeter can be maximized for transient response (lack of hangover), and sound density. The high frequency output will correspond more closely to the audio input.

For optimum performance of tweeter 12, the axial spacing between piston 44 and diaphragm 24 should be controlled within limits. The axial spacing should be marginally less than the piston 44 diameter in order to maintain the columnar, (non-divergent) character of the pressure wave generated by piston 44. Typically, the axial spacing between the piston and diaphragm is about three fourth the piston diameter. In a practical real-life system the axial spacing will be about twenty millimeters.

The high frequency wave radiating from columnar space 52 travels through an annular throat formed by the upper surface of woofer diaphragm 24 and an annular edge 57 of tweeter housing 42. The annular throat acts as a wave guide to somewhat control the forming radial wave as to its direction and density. The total area of the annular throat is roughly related to the face area of piston 44 (which initially generates the pressure wave), in that the throat area is only marginally greater than the piston face area. A two to one ratio is suitable.

It might be supposed that movable diaphragm 24 would distort the pressure wave generated by piston 44. However, in practice there is no measurable distortion. Diaphragm 24 is moving generally at different times than piston 44, since the diaphragm responds to low frequency signals, whereas piston 44 responds to high frequency signals. The different signals span different time periods, so that diaphragm 24 is generally motionless while it is acting as a reflector for the pressure wave generated by piston 44.

The illustrated speaker system produces a relatively smooth roll-off of sound, especially off-axis (i.e. relative to movement axis 40). The integration of energy from the two tweeters 12 and 14 creates a relatively dense sound field, which tends to create a wide, even sound dispersion.

The woofer and both tweeters have the same acoustical center (or axis) which tends to produce a clearer coherent sound output. The system produces a relatively smooth seamless transition between woofer and tweeter sound outputs.

The drawings show a specific structural arrangement embodying the invention. However, it will be appreciated that the invention can take various forms and configurations.

What is claimed:

1. An audio speaker system comprising:
a woofer for reproducijng low frequency sounds, and two tweeters for reproducing high frequency sounds;
said woofer comprising a relatively large diaphragm having a movement axis;
one of said tweeters comprising a first relatively small diameter diaphragm centered on said axis said first tweeter diaphragm facing toward the woofer diaphragm for generating a first high frequency wave in the space between the two diaphragms;
the other tweeter comprising a second relatively small diameter diaphragm centered on said axis, said second tweeter diaphragm facing away from the woofer diaphragm for generating a second high frequency wave centered on the movement axis;
said woofer diaphragm being spaced from said first tweeter diaphragm so that the first high frequency wave is reflected from the woofer diaphragm into an annular zone surrounding said tweeters, whereby the two high frequency waves merge.

2. The speaker system of claim 1 wherein the woofer diaphragm has a concave dish-like surface presented to the first tweeter diaphragm; said concave surface being free of discontinuities that might tend to interfere with travel of the first high frequency wave along the concave surface.

3. The speaker system of claim 1, wherein said one tweeter has a peripheral edge spaced from the woofer diaphragm to form an annular throat; said annular throat having an area that is marginally greater than the effective area of said first tweeter diaphragm.

4. The speaker system of claim 1, wherein said one tweeter has an outer peripheral edge spaced from the woofer diaphragm to form an annular throat; said annular throat extending radially outwardly from the projected image of said first tweeter diaphragm to guide the first high frequency wave.

5. The speaker system of claim 1, wherein said first tweeter diaphragm is a piston having an essentially flat surface presented to the woofer diaphragm; said piston having a diameter that is marginably greater than the distance measured from the piston to the woofer diaphragm.

6. The speaker system of claim 5, wherein the woofer diaphragm has a concave dish-like surface presentd to said piston for minimizing divergence of the first high frequency wave during the wave generation process.

7. The speaker system of claim 1, wherein said first tweeter diaphragm is spaced from the woofer diaphragm by a distance that measures approximately twenty millimeters.

8. The speaker system of claim 1, wherein said woofer diaphragm has a concave dish-like surface presented to the first tweeter diaphragm; said tweeters being located on the woofer diaphragm movement axis in back-to-back relation; said one tweeter being located within the concavity formed by the woofer diaphragm so that the first tweeter diaphragm is in near proximity to the woofer diaphragm.
